(19) United States
(12) Patent Application Publication
(10) Pub. No.: US 2010/0045938 A1
(43) Pub. Date: Feb. 25, 2010

(54) OPTICAL SYSTEM FOR PROJECTION DEVICE

(75) Inventors: Ming-Te LIN, Tu-Cheng (TW); Yi-Ping HSIEH, Tu-Cheng (TW); Wei-Ping HSU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/406,057

(22) Filed: Mar. 17, 2009

(30) Foreign Application Priority Data
Aug. 20, 2008 (CN) 200810304111.6

(51) Int. Cl. G03B 21/28

(52) U.S. Cl. 353/33

(57) ABSTRACT

An optical system for a projection device is disclosed. The projection device includes three different light sources, three condensers corresponding to the light sources, an integrator, an optical lens array, a total internal reflection prism, a digital micro-mirror device and a projection lens. The light sources generate light transmitting through the condensers, the integrator, the optical lens array, the total internal reflection prism, and the digital micro-mirror device into the projection lens. The optical system includes an emitting and reflecting module emitting and reflecting light from the light sources to the integrator and comprises a first, second emitting and reflecting mirrors intersecting thereto, the intersections of the first, second emitting and reflecting mirrors facing the corresponding light sources and condensers.

### BACKGROUND

1. Technical Field

The disclosure relates to optical systems and, particularly, to an optical system for use in a projection device.

2. Description of the Related Art

Currently, many projectors use light emitting diodes (LEDs) as light sources. To produce color images, three (or more) groups of the different color LEDs and their optics are required. Accordingly, arrangement of these three groups of the LEDs and the optics becomes a challenge to miniaturize projectors, since such arrangement can increase the projectors' volume.

Therefore, it is desirable to provide an optical system for a projection device which can overcome the described limitations.

### BRIEF DESCRIPTION OF THE DRAWINGS

Many aspects of the disclosure can be better understood with reference to the drawings. The components in the drawings are not necessarily drawn to scale, the emphasis instead being placed upon clearly illustrating the principles of the optical system. Moreover, in the drawings, like reference numerals designate corresponding parts throughout the views.

FIG. 1 is a schematic view of a first embodiment of an optical system, according to the disclosure.

FIG. 2 is a schematic view of a second embodiment of an optical system, according to the disclosure.

FIG. 3 is a schematic view of a third embodiment of an optical system, according to the disclosure.

### DETAILED DESCRIPTION OF THE EMBODIMENTS

Embodiments of the optical system for the projection device are described in detail here with reference to the drawings.

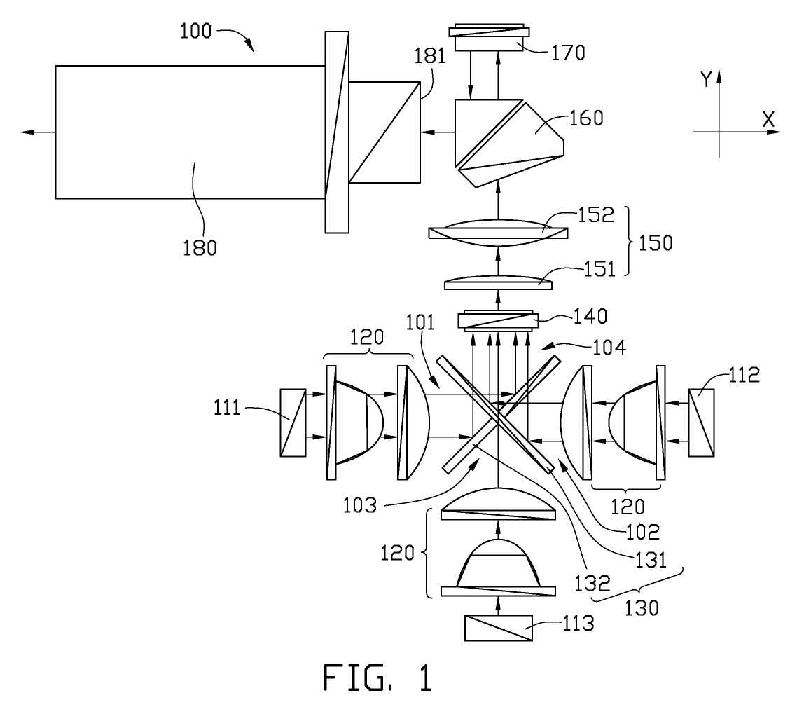

As shown in FIG. 1, a first embodiment of an optical system 100 includes first, second, and third light sources 111, 112, and 113, three condensers 120, a cross-dichroic mirror set 130, an integrator 140, an optical lens array 150, a total internal reflection (TIR) prism 160, a digital micro-mirror device (DMD) 170, and a projection lens 180.

Here, the first, second, and third light sources 111, 112, and 113 are LED light sources, respectively generating red, green, and blue light.

The three condensers 120 are positioned respectively along corresponding light paths of the first, second, and third light sources 111, 112, and 113 and transmit the different color light to the cross-dichroic mirror set 130.

The cross-dichroic mirror set 130 selectively reflects a portion (spectrum) of light and transmits the remaining portion of light (the remaining spectrum). The cross-dichroic mirror set 130 includes a first dichroic mirror 131 and a second dichroic mirror 132 intersecting the first dichroic mirror 131 transversely. In an example, the first dichroic mirror 131 has a reflective coating which can reflect the red light emitted from the three condensers 120 but transmit the blue and green light. Here, the second dichroic mirror 132 has a reflective coating which reflects green light emitted from the three condensers 120 and transmits blue and red light, although color or colors can be chosen to be reflected. Alternatively, the first and second dichroic mirrors 131 and 132 can be coated with other reflective coatings depending on the types of the light sources.

The first dichroic mirror 131 includes a first surface 101 and a second surface 102 opposite thereto. The second dichroic mirror 132 includes a third surface 103 and a fourth surface 104 opposite thereto. In detail, the first light source 111 faces the intersecting point of the first surface 101 and the fourth surface 104 along an X-axis. The second light source 112 faces the intersecting point of the second surface 102 and the third surface 103 along the X-axis. The third light source 113 faces the intersecting point of the first surface 101 and the third surface 103 along a Y-axis.

The integrator 140 faces the intersecting point of the second surface 102 and the fourth surface 104 along the Y-axis. The integrator 140 normalizes the colored light directed from the second and fourth surfaces 102, 104 of the cross-dichroic mirror set 130, thereby providing uniform light illumination that matches the DMD 170 in shape.

The optical lens array 150 includes a first optical lens 151 and a second optical lens 152 positioned along the path of the emitted light from the integrator 140 along the Y-axis. The optical lens array 150 collects the sequential light to produce illumination through the TIR prism 160 onto the DMD 170.

The TIR prism 160 includes two triangular prisms arranged in such a way that the hypotenuse surfaces thereof are fixed to each other with a gap therebetween, and is configured to change the emitting light path.

The DMD 170 transits between active “on” and “off” states to selectively communicate at least a portion of the light. In this example, the DMD 170 tilts in a positive or negative orientation until contacting a mirror stop (not explicitly shown). In an “on” state, the DMD 170 receives the light emitted from the TIR prism 160 and reflects the emitted light to the TIR prism 160, thereby modulating the illumination incident thereon into optical images.

The projection lens 180 includes an entrance 181 through which light is received and thereby projects the optical images on a screen (not shown).

In the first embodiment, the light from the first, second, and third light sources 111, 112, and 113 travels through the three condensers 120 to the cross-dichroic mirror set 130 and then is emitted through the integrator 140 for normalization. The normalized light is concentrated by the optical lens array 150 and transmitted into the TIR prism 160. The light is emitted into the DMD 170 and reflects through the TIR prism 160 into the projection lens 180, projecting optical images.

For example, the third light source 113, one of the condensers 120, the cross-dichroic mirror set 130, the integrator 140, the optical lens array 150, the TIR prism 160, the DMD 170 can be positioned along the Y-axis perpendicular to the entrance 181. The first light source 111 and the second light source 112, along the X-axis, are positioned on the first surface 101 and the second surface 102, respectively. Therefore, the optical system 100 utilizes the cross-dichroic mirror set 130 received therein and the optical components arranged facing the cross-dichroic mirror set 130 along the X-axis, such as the first light source 111, the corresponding condenser 120 aligned therewith, the second light source 112, and the corresponding condenser 120 aligned therewith, thereby shortening the length of the projection lens 180.

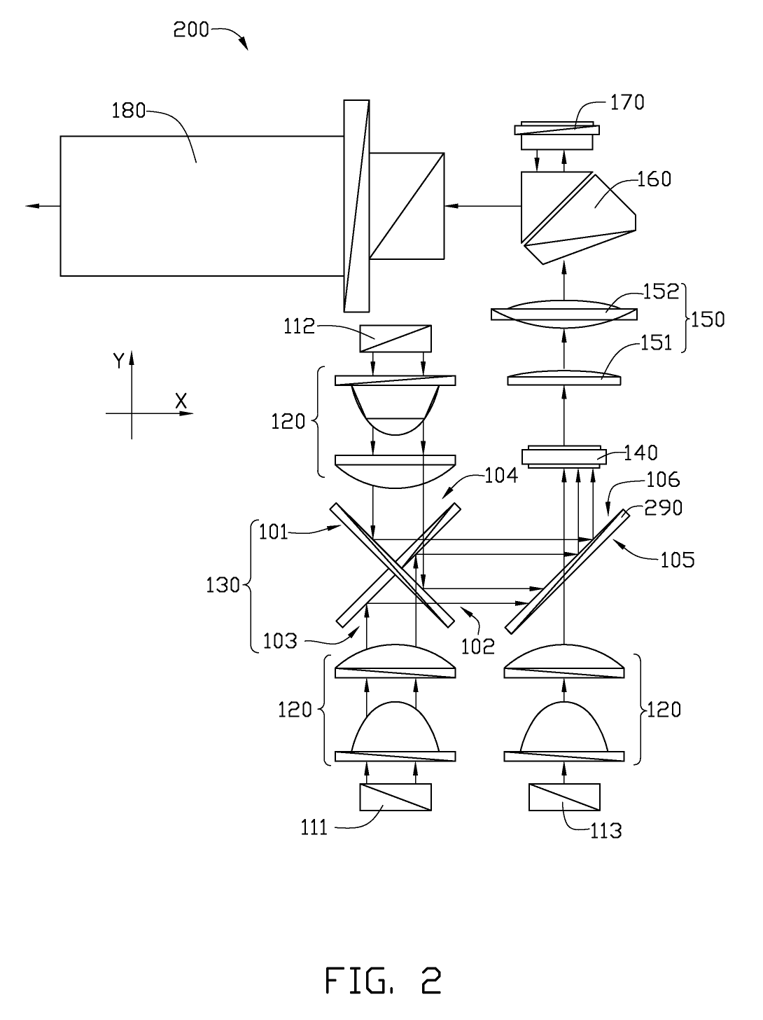

In FIG. 2, a second embodiment of an optical system 200 is shown, differing from the optical system 100 only in the inclusion of a third dichroic mirror 290 and in the arrangement of the first, second, and third light sources 111, 112, and 113.

The third dichroic mirror 290 here adjoins the cross-dichroic mirror set 130 and utilizes blue light transmission and reflects red and green light. The third dichroic mirror 290 includes a fifth surface 105 and a sixth surface 106. The fifth surface 105 faces the third light source 113. The sixth surface 106 is positioned facing the integrator 140 and thereby the optical lens array 150, and the TIR prism 160 and DMD 170 are positioned in an emissive pathway of the integrator 140.

The first light source 111 and the second light source 112, along the Y-axis are opposite and face the first surface 101 and the second surface 102, respectively. The third light source 113 adjoins the first light source 111 in parallel.

In a system of the second embodiment, the light from the first, second light sources 111, 112 travels through and is reflected from the cross-dichroic mirror set 130, thereby emitting through the third dichroic mirror 290 into the integrator 140. Here, the light from the third light source 113 is emitted through the third dichroic mirror 290 into the integrator 140.

In an example, the optical system 200 can utilize the optical components arranged along the X-axis, such as the cross-dichroic mirror set 130 and the third dichroic mirror 290, thus shortening the length of the projection lens 180.

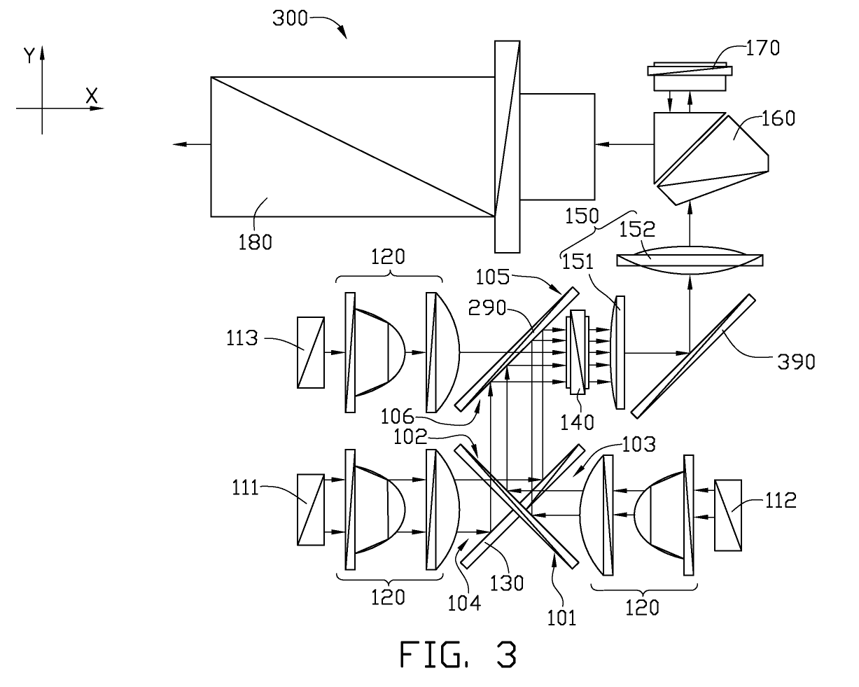

In FIG. 3, a third embodiment of an optical system 300 is shown, differing from the optical system 200 only in the inclusion of a reflector 390 and a different arrangement of the first, second, and third light sources 111, 112, and 113.

The first light source 111 and the second light source 112, along the X-axis, are positioned beside the corresponding second surface 102 and the corresponding first surface 101 of the cross-dichroic mirror set 130. The third light source 113, along the X-axis direction, is aligned parallel with the first light source 111. The third light source 113 adjoins the fifth surface 105 which is parallel to the second surface 102 in the Y-axis and parallel to the reflector 390 in the X-axis. The first optical lens 151 and the second optical lens 152 adjoin to the reflector 390 and are perpendicular to each other. The integrator 140 is positioned between the first optical lens 151 and the sixth surface 106. The TIR prism 160 and the DMD 170, along the Y-axis, are arranged in the transmitting path of the second optical lens 152 in sequence.

In a transmission of light by the third embodiment, the light from the integrator 140 travels through the first optical lens 151 to the reflector 390 to reflect, thereby the light emitting through the second optical lens 152.

Here as an example, the components in the optical system 300, along the X-axis, are arranged in two rows. The components in one of the rows include the third light source 113, the condenser 120 corresponding to the third light source 113, the third dichroic mirror 290, the integrator 140, the first optical lens 151 and the reflector 150 in sequence. There are fewer components along the X-axis in this example than in a generally used optical system, thereby shortening the length of the projection lens 180.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical system for a projection device, the projection device comprising three different light sources, three condensers corresponding to the light sources, respectively, an integrator, an optical lens array, a total internal reflection prism, a digital micro-mirror device and a projection lens, the light sources being configured for emitting light through the condensers, the integrator, the optical lens array, the total internal reflection prism, and the digital micro-mirror device into the projection device, comprising:
an emitting and reflecting module capable of emitting and reflecting light from the light sources to the integrator, and comprising a first emitting and reflecting mirror and a second emitting and reflecting mirror intersecting the first emitting and reflecting mirror, the intersections of the first, second emitting and reflecting mirrors facing the corresponding light sources and the corresponding condensers.

2. The optical system of claim 1, wherein the first emitting and reflecting mirror comprises a first surface and a second surface opposite to the first surface; the second emitting and reflecting mirror comprising a third surface and a fourth surface opposite to the third surface.

3. The optical system of claim 2, wherein one of the three light sources and the corresponding condenser face the first surface and the fourth surface; another of the three light sources and the corresponding condenser face the first surface and the third surface; the other of the three light sources and the corresponding condenser face the second surface and the third surface.

4. The optical system of claim 2, further comprising a third emitting and reflecting mirror positioned aligned with the emitting and reflecting module along a X-axis, the third emitting and reflecting mirror comprising a fifth surface and a sixth surface parallel to the fourth surface.

5. The optical system of claim 4, wherein one of the three light sources and the corresponding condenser face the first surface and the third surface; another of the three light sources and the corresponding condenser face the second surface and the fourth surface; and the other of the three light sources and the corresponding condenser face the fifth surface.

6. The optical system of claim 4, wherein the integrator, the optical lens array, the total internal reflection prism, and the digital micro-mirror device are arranged along the X-axis in the light path of the third emitting and reflecting mirror.

7. The optical system of claim 4, wherein the projection lens receives the light emitted from the total internal reflection prism.

8. The optical system of claim 2, further comprising a third emitting and reflecting mirror positioned aligned with the emitting and reflecting module along a Y-axis, the third emitting and reflecting mirror comprising a fifth surface and a sixth surface parallel to the fourth surface.

9. The optical system of claim 8, wherein one of the three light sources and the corresponding condenser face the first surface and the fourth surface; another of the three light sources and the corresponding condenser face the second surface and the third surface; the other of the three light sources and the corresponding condenser face the fifth surface.

10. The optical system of claim 8, further comprising a reflector facing the third emitting and reflecting mirror parallelly.

11. The optical system of claim 10, wherein the optical lens array comprises a first optical lens and a second optical lens perpendicular to the first optical lens.

12. The optical system of claim 10, wherein the integrator and the first optical lens are positioned between the third emitting and reflecting mirror and the reflector and parallel to each other.

13. The optical system of claim 12, wherein the second optical lens, the total internal reflection prism, the digital micro-mirror device are arranged in the path of the light emitted from the reflector.

14. The optical system of claim 13, wherein the projection lens is positioned along the Y-axis and receives the light emitted from the total internal reflection prism.

15. An optical system for a projection device, comprising:
a first and second light sources;
an integrator; and
an emitting and reflecting module capable of emitting and reflecting light from the light sources to the integrator, and comprising a first emitting and reflecting mirror and a second emitting and reflecting mirror intersecting the first emitting and reflecting mirror, the intersections of the first, second emitting and reflecting mirrors facing the corresponding light sources and the corresponding condensers; the first and second light sources face a first and second sides of the emitting and reflecting module and opposite to each other.

16. The optical system of claim 15, wherein the first emitting and reflecting mirror comprises a first surface and a second surface opposite to the first surface; the second emitting and reflecting mirror comprising a third surface and a fourth surface opposite to the third surface.

17. The optical system of claim 16, wherein the first light source faces the first and fourth surfaces and the second light source face the two and third surfaces.

18. The optical system of claim 17, further comprising a third light source facing the first and third surfaces and an integrator facing the second and fourth surfaces.

19. The optical system of claim 16, further comprising a third emitting and reflecting facing a third side of the emitting and reflecting module and parallel to the second emitting and reflecting mirror, and a third light source facing the third emitting and reflecting mirror.
